(19) United States
(12) Patent Application Publication
(10) Pub. No.: US 2009/0084774 A1
(43) Pub. Date: Apr. 2, 2009

(54) METHOD FOR JOINING DISSIMILAR MATERIALS

(75) Inventors: Taisei Wakisaka, Hagagun (JP); Toru Kumagai, Hagagun (JP); Mitsugu Kaneko, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/236,745

(22) Filed: Sep. 24, 2008

(30) Foreign Application Priority Data
Sep. 28, 2007 (JP) 2007-253671

(51) Int. Cl. H05B 6/10

(52) U.S. Cl. 219/633

(57) ABSTRACT

A method for joining dissimilar materials by superposing, one over the other, a first material and a second material having a larger intrinsic resistance than that of the first material, heating the second material and pressing the first material and the second material against each other, which comprises conducting induction heating only from the side of the first material upon heating the second material to thereby heat the second material at the portions in contact with the first material.

### BACKGROUND OF THE INVENTION

1. Field of the Invention

The present invention relates to a method for joining dissimilar materials. More particularly, it relates to a method for joining dissimilar materials such as aluminum material and steel material each having a different intrinsic resistance from each other.

2. Description of Related Art

As well as a steel plate containing a ferrous material, materials prepared by joining dissimilar materials such as a steel plate and an aluminum material (a material containing aluminum or the alloy thereof) to each other have conventionally been used for parts of automobiles. Such materials formed by joining dissimilar materials have different, plural properties and, therefore, they are widely employed for various parts of automobiles for the purpose of, for example, weight reduction and improvement of corrosion resistance.

When joining such dissimilar materials, two materials are joined to each other by heating and pressing against each other while contacting each other to thereby mutually diffuse atoms constituting the respective materials through the joined interface. However, it is known that, when joining, for example, a steel material to an aluminum plate, sufficient joining strength cannot be obtained if a fragile intermetallic compound is generated at the joined interface during the joining process. Further, it is also known that, since such fragile intermetallic compound is generated by diffusion of iron into aluminum during cooling a work after heating the work to temperature necessary for joining, rapid cooling is desirable for joining dissimilar materials with a sufficient strength.

Thus, Japanese Patent Examined Publication JP-B-3692135 shows a laser roll joining method. In the laser roll joining method, only a steel plate is irradiated with the laser to heat, and then this steel plate is rolled between pressure rolls together with an aluminum plate. More specifically, in this laser roll joining method, the steel plate and the aluminum plate are conveyed by a pair of pressure rollers, at an upstream side of the pressure rollers, the steel plate is bent back so that only the joining portion of the steel plate receives laser light and then each of the plates are contacted and pressed by the pressure rollers. Thus, in the method of the JP-B-3692135, only the steel plate is heated up to necessary temperature for shortening the time required for the cooling, thereby preventing generation of the fragile intermetallic compound as described above.

However, in this joining method, the plates should be rolled while bending the steel plate. Therefore, it is impossible to spot-join materials having a three-dimensional shape such as automobile parts. Therefore, there has been demands for a method of joining dissimilar materials which can suppress generation of the fragile intermetallic compound in a manner different from the method shown in the JP-B-3692135.

### SUMMARY OF THE INVENTION

The present invention has been made in consideration of the above-described problem, and an object of the present invention is to provide a method for joining dissimilar materials with ensuring sufficient joining strength.

According to an aspect of the invention, there is provided a method for joining dissimilar materials, including:

superposing a first material and a second material each other;

heating the second material and

pressing the first material and the second material against each other,

wherein when heating the second material, induction heating is carried out only from a side of the first material so that a portion of the second material, which contacts with the first material, is heated and

the second material has a larger intrinsic resistance than that of the first material.

Further, according another aspect of the invention, there is provided a method for joining dissimilar materials, including:

contacting a joining portion of a first material with a joining portion of a second material;

allocating an induction coil to a surface of the first material, which is an opposite side relative to a surface on which the joining portion exists, at a position corresponding to the joining portion of the second material;

supplying current to the induction coil so as to heat the joining portion of the second material and

pressing the first material and the second material against each other,

wherein an intrinsic resistance of the first material is lower than that of the second material.

According to the invention, by appropriately setting the electric current and the frequency for conducting induction heating when heating the second material, only the second material can be rapidly heated to predetermined temperature without unnecessarily heating the first material. Thus, generation of the fragile intermetallic compound is suppressed and sufficient joining strength can be obtained by heating only the second material and pressing the first and second materials each other.

In addition, as to the first and second materials which are superposed each other, the induction heating is carried out from the first material side. Therefore, the portion of the second material which contacts with the first material can be heated concentratedly. Therefore, according to the present invention, in comparison with the case where, for example, conducting induction heating from both sides of the first and second materials, unnecessary heating of the second material can be eliminated. Thus, the time required for cooling after pressuring can be made shorter and generation of the fragile intermetallic compound can be suppressed.

Also, since the second material is heated by induction heating, spot joining is can be achieved regardless of the shapes of the first and second materials.

Preferably, the first material contains aluminum or magnesium and the second material preferably contains iron or titanium.

According to the invention, use of the materials containing these materials realizes production of materials having a reduced weight and an excellent corrosion resistance and being suited for automobile parts with sufficient joining strength.

According to the method of the present invention, the second material can be heated selectively at the portions which contacts with the first material, and hence the time necessary for cooling after pressuring can be more shortened and generation of the fragile intermetallic compound can be more reduced.

### BRIEF DESCRIPTION OF THE DRAWINGS

FIG. 1 is a schematic view showing operation of the induction heating process according to one embodiment of the present invention and

FIG. 2 is a schematic view showing operation of the press-joining process according to the embodiment of the present invention.

### DETAILED DESCRIPTION OF THE PREFERRED EMBODIMENTS

An embodiment of the present invention will be described below based on drawings.

The method of this embodiment for joining dissimilar materials is a method of joining an aluminum material 1 which is the first material and a steel material 2 which is the second material having a larger intrinsic resistance than that of the aluminum material 1 to each other by diffusion joining, and includes an induction heating process and a press-joining process.

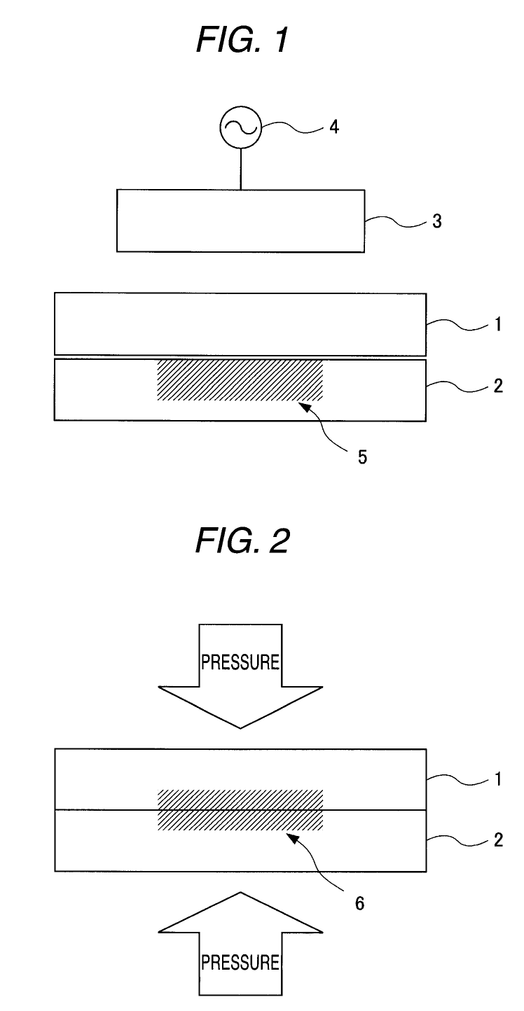

First, the induction heating process will be described below by reference to FIG. 1.

In this induction heating process, the aluminum plate 1 and the steel plate 2 are disposed in a mutually superposed state on a working board (not shown) having a high frequency coil (induction coil) 3.

Next, the high frequency coil 3 is set at a predetermined position. Here, as shown in FIG. 1, the high frequency coil 3 is positioned only on a side of the aluminum material 1 with respect to the mutually superposed aluminum material 1 and the steel plate 2, and the position of the high frequency coil 3 is adjusted so that the magnetic flux generated from the high frequency coil 3 penetrates through the joined portion of the aluminum material 1 and the steel material 2.

Next, adjusting output of a high frequency power source 4 and energizing the high frequency coil 3 to thereby heat only the steel plate 2 to predetermined joining temperature. That is, the high frequency coil 3 is energized by high frequency power source 4 to generate magnetic flux penetrating through the steel material 2 and produce induction current in the steel material 2, then the steel material 2 is heated.

Here, the electric current and the frequency of the output of the high frequency power source 4 are appropriately set depending upon the component, shape and plate thickness of each of the aluminum material 1 and the steel material 2 and upon distance between the high frequency coil 3 and the steel material 2 so that, of the mutually superposed aluminum material 1 and the steel material 2, only the steel material 2 can be induction-heated at the portion of the steel material 2 which contacts with the aluminum material 1. Also, the joining temperature is appropriately set depending upon the component of each of the aluminum material 1 and the steel material 2 so that sufficient joining strength can be obtained.

Thus, as indicated by a region 5 in FIG. 1, the steel material 2 can selectively be induction-heated to an appropriate joining temperature at the portion which contacts with the aluminum material 1.

Next, the press-joining process will be described below by reference to FIG. 2.

In this press-joining process, the joined portions of the aluminum material 1 and the heated steel material 2 are pressed from both sides of the aluminum material 1 and the steel material 2 over a predetermined pressing time with a predetermined joining pressure. Accordingly, the aluminum material 1 is heated at the portion which contacts with the steel material 2 as indicated by a region 6 in FIG. 2 due to thermal conduction from the steel material 2 to cause mutual diffusion at the joined portions of the both materials 1 and 2, thus the aluminum material 1 and the steel material 2 are joined to each other.

Here, the joining pressure to be applied to the joined portions and the pressing time are appropriately set depending upon the component, shape and plate thickness of each of the aluminum material 1 and the steel material 2 and upon the joining temperature of the steel material 2. Further, in this press-joining process, as means for applying pressure to the aluminum material 1 and the steel material 2, there can be employed, for example, an actuator such as an oil hydraulic cylinder or an air cylinder.

The method of this embodiment for joining dissimilar materials provides the following operation effects.

By appropriately setting the current and the frequency for conducting induction heating, when heating the steel material 2, only the steel material can be rapidly heated to a predetermined temperature without unnecessarily heating the aluminum material 1. When heating only the steel material 2 in this manner and pressuring the aluminum material 1 and the steel material 2, production of the fragile intermetallic compound can be suppressed and sufficient joining strength can be obtained.

In addition, particularly here, the steel material 2 can be selectively heated at the portion which contacts with the aluminum material 1 by subjecting the mutually superposed aluminum material 1 and the steel material 2 to induction heating from only the side of the aluminum material 1. Therefore, according to the present invention, in comparison with the case where, for example, conducting the induction heating from both sides of the aluminum material 1 and the steel material 2, unnecessary heat is not supplied to the steel material 2. Thus, the time necessary for cooling after pressing can be shortened and generation of the fragile intermetallic compound can be suppressed.

Further, since the steel material is heated by induction heating, spot joining can be achieved regardless of the shapes of the steel material 2 and the aluminum material 1.

The invention is not limited only to the above-described embodiment and modifications and improvements within the scope capable of attaining the object of the invention are included in the invention.

In the above-described embodiment, the aluminum material 1 and the steel material 2 are used as the first material and the second material, respectively. However, they are not limitative at all. As the first material and the second material, any materials each having a different intrinsic resistance from each other may be employed. More specifically, as the first material, any material containing magnesium may be used as well as aluminum, Further, as the second material, any material containing titanium may be used as well as iron.

Use of the materials containing these materials realizes production of materials having a reduced weight and an excellent corrosion resistance and being suited for automobile parts with sufficient joining strength.

While the invention has been described in connection with the exemplary embodiments, it will be obvious to those skilled in the art that various changes and modifications may be made therein without departing from the present invention, and it is aimed, therefore, to cover in the appended claim all such changes and modifications as fall within the true spirit and scope of the present invention.

What is claimed is:

1. A method for joining dissimilar materials, comprising:
superposing a first material and a second material each other;
heating the second material and
pressing the first material and the second material against each other,
wherein when heating the second material, induction heating is carried out only from a side of the first material so that a portion of the second material, which contacts with the first material, is heated and
the second material has a larger intrinsic resistance than that of the first material.

2. The method for joining dissimilar materials according to claim 1, wherein
the first material comprises aluminum or magnesium and
the second material comprises iron or titanium.

3. A method for joining dissimilar materials, comprising:
contacting a joining portion of a first material with a joining portion of a second material;
allocating an induction coil to a surface of the first material, which is an opposite side relative to a surface on which the joining portion exists, at a position corresponding to the joining portion of the second material;
supplying current to the induction coil so as to heat the joining portion of the second material and
pressing the first material and the second material against each other,
wherein an intrinsic resistance of the first material is lower than that of the second material.

4. The method for joining dissimilar materials according to claim 3, wherein
the first material comprises aluminum or magnesium and
the second material comprises iron or titanium.
